(19) United States
(12) Patent Application Publication
(10) Pub. No.: US 2026/0231103 A1
(43) Pub. Date: Aug. 6, 2026

(54) ACQUISITION OF POSITIONING REFERENCE SIGNALS FOR DEVICE GROUPS

(71) Applicant: ResMed Inc., San Diego, CA (US)

(72) Inventor: Guorong Gordon HUANG, Poway, CA (US)

(21) Appl. No.: 19/460,983

(22) Filed: Jan. 27, 2026

Related U.S. Application Data
(60) Provisional application No. 63/752,548, filed on Jan. 31, 2025.

(51) Int. Cl. H04W 64/00; H04L 5/00; H04W 24/08; H04W 24/10

(52) U.S. Cl. CPC H04W 64/00; H04L 5/0048; H04W 24/08; H04W 24/10

(57) ABSTRACT

One or more methods and apparatuses associated with cellular systems is disclosed herein. A method can be for grouping devices that share at least one common characteristic to form a group, assigning a master device, and initiating a request on behalf of the group. The request message cam contain a group identification (group ID) and can be sent to a network. The method can include receiving and processing PRS signals by the devices in the group. The common characteristics can include device type, application type, RF characteristics, device capabilities, traffic patterns, or location. The master device can be assigned through various methods such as fixed assignment, random selection, rotating assignment, or designation. The request message can include an on-demand mobile-originated location request (MO-LR) message or a location service request message, which can further contain the group ID and identification of each device.

### CROSS-REFERENCE TO RELATED APPLICATIONS

This application claims priority to U.S. Provisional Application No. 63/752,548, filed Jan. 31, 2025, which is hereby incorporated by reference in its entirety.

### BACKGROUND

### Field of the Disclosure

Aspects of the present disclosure relate to wireless communications, and more particularly, to systems, devices, methods, and techniques for managing acquisition of positioning reference signals for device groups in cellular networks.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

A communication system may include a wireless communication network (such as a radio access network (RAN)) that supports communication between wireless communication devices such as network entities (such as base stations (BSs)), client devices (such as one or more user equipments (UEs)), and others. Such devices may communicate with one another using a variety of protocols (e.g., radio access technologies (RATs) that have been adopted in various telecommunication standards, which define common protocols that enable different wireless communication devices to communicate on a local, municipal, national, regional, or global level, including those of cellular-based systems such as fourth generation (4G) systems (e.g., Long Term Evolution (LTE) systems), fifth generation (5G) systems (such as 5G New Radio (5G-NR) systems), and sixth generation (6G) systems that are part of a continuous mobile broadband evolution promulgated by the Third Generation Partnership Project (3GPP). A wireless communication network may support communication by implementing system resources (such as frequency resources, time resources, spatial resources) in accordance with a wireless communication protocol.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like.

The Positioning Reference Signal (PRS) was defined in 3GPP Release 16. PRS is used in the downlink to support high-accuracy positioning in 5G networks, providing enhanced accuracy, coverage, and interference management compared to LTE. On-demand PRS was introduced in 3GPP Release 17. On-demand PRS allows for more flexible and efficient positioning in 5G networks by enabling the UE to request PRS transmissions when needed, rather than relying solely on periodic or scheduled broadcasts. This enhancement in Release 17 aims to improve positioning accuracy, reduce network overhead, and provide more dynamic positioning capabilities in 5G networks. However, on-demand PRS can result in a substantial surge of requests, potentially inundating the network due to the PRS signal's shared nature and can also bring in other undesirable drawbacks.

Consequently, there exists a need for further improvements in wireless communications systems to overcome the aforementioned technical challenges and others.

### SUMMARY

One aspect provides a method for wireless communication by a UE. The method includes initiating, by a master device of a group of one or more devices that share at least one common characteristic, a request on behalf of the group. Initiating the request comprises sending a request message to a network entity for a positioning reference signal (PRS). The request message contains a group identification (ID).

One aspect provides a method for wireless communication by a network entity. The method includes receiving a request message from a master device, of a group of one or more devices, on behalf of the group. The request message contains a group identification (ID) of the group. The request message is for a positioning reference signal (PRS). The method includes transmitting a PRS to at least one of the one or more devices in the group in response to the request message.

According to an aspect of the present disclosure, a method is provided for grouping one or more devices that share at least one common characteristic to form a group, assigning a device as a master device of the group, initiating, by the master device, a request on behalf of the group, wherein the request is a request message that contains a group identification (group ID), and wherein initiating the request includes sending the request message to a network; and receiving and processing position reference signal (PRS) by at least one device of in the group. In one or more aspects, the master device can be i) a fixed assignment, ii) a random selection, iii) a rotating assignment, or iv) a designated device.

According to another aspect of the current disclosure, the at least one common characteristic further includes one or more characteristics of: a type of devices, a type of application, one or more radio frequency characteristics, one or more device capabilities, one or more traffic patterns, or one or more locations. In one or more aspects, the location includes being by, in, or otherwise associated with one or more base stations or cells and/or a pre-defined area. In one or more aspects, the location includes being by, in, or otherwise associated with i) one or more base stations, ii) one or more cells and/or iii) a pre-defined area In one or more aspects, the location further includes being inside one of these areas: covered by one or more base stations or cells (e.g. one or more cells), or a pre-defined area. In one more aspects, the location further includes being inside one of these areas: covered by i) one or more base stations, ii) one or more cells, or a iii) pre-defined area.

In one or more aspects, the request message further includes i) an on-demand mobile-originated location request (MO-LR) message or ii) a location service request message. In accordance one or more aspects, the on-demand mobile-originated location request (MO-LR) message or ii) the location service request message further includes a) the group ID and b) an indication the request is from the master of the group on behalf of the group, and wherein i) the on-demand mobile-originated location request (MO-LR) message or ii) the location service request message further includes identification (ID) of each device in the group.

In accordance with one or more aspects, the on-demand mobile-originated location request (MO-LR) message or the location service request message further includes a on demand downlink positioning reference signal request (NR-On-Demand-DL-PRS-Request), wherein the NR-On-Demand-DL-PRS-Request a positioning reference signal (PRS) transmission request with request of a start time and a duration.

In one or more aspects, the at least one device further include measuring and processing of PRS signals. In accordance with one or more aspects, the at least one device further includes sending reports of measurement to the network, e.g. the method can include sending one or more reports of one or more measurements (e.g. a measurement) to the network using the at least one device. In one or more aspects, the at least one device further includes receiving assistance data from the network, e.g. the method can include receiving assistance data from the network using the at least on device.

In accordance with one or more aspects of the present disclosure, an apparatus is provided including at least one processor and at least one memory including computer program code. The at least one memory and the computer program code are configured to, with the at least one processor, cause the apparatus to perform at least the following: group one or more devices that share at least one common characteristic to form a group, assign a device as a master device of the group, initiate, by the master device, a request on behalf of the group, wherein the request is a request message that contains a group identification (group ID), and wherein initiating the request includes sending the request message to a network; and receive and process position reference signal (PRS) by at least one device of in the group. In one or more aspects, the master device is assigned by i) a fixed assignment, ii) a random selection, iii) a rotating assignment, or iv) a designated device.

In one or more aspects, a method is provided including receiving a request message from a master device on behalf of one or more devices in a group, wherein the request message contains a group identification (group ID) of the group, determining if the request message is for i) positioning reference signal (PRS) transmission or ii) for PRS transmission characteristics change or update, initiating PRS configuration exchange procedure by sending PRS configuration request to the one of more devices in the group. In accordance with one or more aspects, the method further includes receiving an individual identification of each of the one or more devices and an indication that the request is from the master of the group on behalf of the one or more devices in the group. In other aspects, the individual identification of each of the one or more devices i) is received as part of the request message from the master device or ii) pre-stored in a network.

In accordance with one or more aspects, the request message further includes i) an on-demand mobile-originated location request (MO-LR) message or ii) a location service request message, wherein i) the on-demand mobile-originated location request (MO-LR) message or ii) the location service request message further includes a) the group ID and b) an indication the request is from the master of the group on behalf of the group, and wherein i) the on-demand mobile-originated location request (MO-LR) message or ii) the location service request message further includes identification (ID) of each device in the group. In one or more aspects, i) the on-demand mobile-originated location request (MO-LR) message or ii) the location service request message further including a on demand downlink positioning reference signal request (NR-On-Demand-DL-PRS-Request), wherein the NR-On-Demand-DL-PRS-Request a positioning reference signal (PRS) transmission request, and the positioning reference signal (PRS) transmission request further includes a start time and a duration.

In one or more aspects, an apparatus is provided including at least one processor and at least one memory including computer program code. The at least one memory and the computer program code are configured to, with the at least one processor, cause the apparatus to perform at least the following: receive a request message from a master device on behalf of one or more devices in a group, wherein the request message contains a group identification (group ID) of the group, determine if the request message is i) for positioning reference signal (PRS) transmission or ii) for PRS transmission characteristics change or update, initiate a PRS configuration exchange procedure by sending a PRS configuration request to the one or more devices. In one or more aspects, the apparatus further is configured (e.g. by the processor causing it to perform): receive individual identification of each of the one or more devices and an indication that the request is from the master of the group on behalf of the one or more devices in the group.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The foregoing general description of the illustrative aspects and the following detailed description thereof are merely exemplary aspects of the teachings of this disclosure and are not restrictive.

### BRIEF DESCRIPTION OF FIGURES

The appended figures depict certain features of the various aspects described herein and are not to be considered limiting of the scope of this disclosure.

FIG. 1 depicts an example wireless communications network.

FIG. 2 is a call flow diagram illustrating example operations by a group of devices and a network entity for acquisition of positioning reference signals (PRS).

FIG. 3 depicts virtual connections among entities.

FIG. 4 depicts a method for wireless communications by a master device.

FIG. 5 depicts a method for wireless communications by a network entity.

FIG. 6 depicts aspects of an example user equipment (UE).

FIG. 7 depicts aspects of an example network entity.

### DETAILED DESCRIPTION

Aspects of the present disclosure provide apparatuses, methods, processing systems, and computer-readable mediums for managing acquisition of positioning reference signals for device groups in cellular networks.

On-demand positioning reference signal (PRS) functionality introduced in 3GPP Release 17 enables user equipment (UE) to request PRS transmissions when needed, rather than relying solely on periodic or scheduled broadcasts. However, when multiple UEs independently initiate on-demand PRS requests, a substantial surge of requests can potentially inundate the network due to the shared nature of PRS signals. This flooding of requests consumes significant radio resources and processing capacity at network entities such as location management functions (LMFs), creating inefficiencies in positioning operations. Additionally, coordinating PRS reception timing among multiple devices with similar positioning requirements presents challenges for efficient resource utilization.

To address these technical challenges, aspects of the present disclosure provide techniques for grouping one or more devices that share at least one common characteristic to form a group and assigning a device as a master device of the group. The master device initiates a request on behalf of the group by sending a request message to a network entity, where the request message contains a group identification (ID) and is for a positioning reference signal. The network entity receives the request message from the master device on behalf of the group and transmits a PRS to at least one of the devices in the group in response. The common characteristics for grouping may include device type, application type, radio frequency characteristics, device capabilities, traffic patterns, or location. The request message may be an on-demand mobile-originated location request (MO-LR) message or a location service request message that includes the group ID and an indication that the request is from the master on behalf of the group. The request message may further contain a requested start time and duration of the PRS transmission, and may include identification of each device in the group.

The disclosed techniques provide significant benefits by reducing network signaling overhead through consolidation of multiple individual PRS requests into a single group request from the master device. This approach results in substantial savings on radio resources as the LMF processes a single request rather than multiple similar or duplicate requests from individual devices. The grouping mechanism enables coordinated PRS reception among devices with similar characteristics, allowing devices in the group to wake up simultaneously to process PRS and make measurements. The flexibility in master device assignment through fixed assignment, random selection, rotating assignment, or designation provides adaptability for various deployment scenarios. Furthermore, the ability to specify PRS start time and duration in the request message enables more efficient scheduling of positioning operations, while the inclusion of device IDs in the request message or pre-storage at the network entity facilitates proper PRS configuration and assistance data distribution to all group members.

### Introduction to Wireless Communications Networks

The techniques and methods described herein may be used for various wireless communications networks. While aspects may be described herein using terminology commonly associated with 4G, 5G, and/or 6G wireless technologies, aspects of the present disclosure may likewise be applicable to other communications systems and standards not explicitly mentioned herein.

A communication system may include a RAN that supports wireless communication. Communication in a RAN may be performed in accordance with one or more RATs, including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread OFDM (DFT-S-OFDM), among others.

A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others. To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

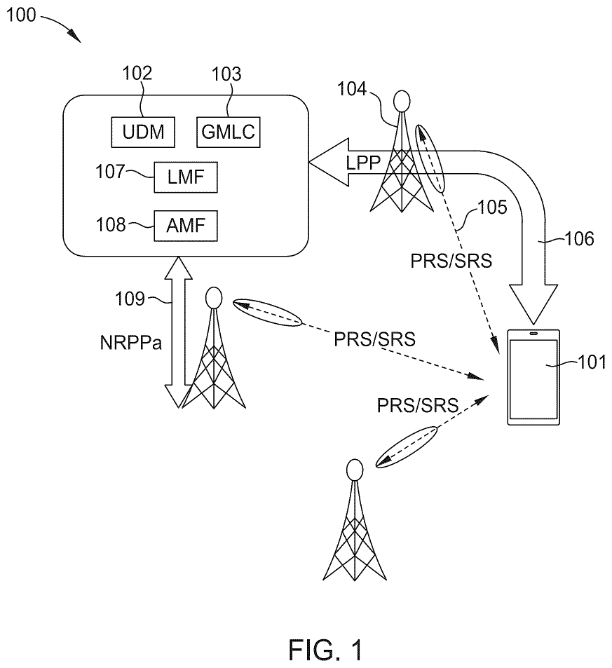

FIG. 1 illustrates an example of cellular system, such as a 5G system. In one or more aspects, system 100 can be associated with positioning architecture using PRS. In one or more aspects, system 100 can also be considered as an illustration of a simplified cellular or wireless system. A cellular or wireless system includes base stations 104, user equipment or user devices 101, and network entities.

A network or core network, not explicitly shown and labelled, is customarily considered to be consistent with base stations and network entities mentioned above. Various functions of a network as well as various devices associated with and interacting with a network may be considered network entities. Further, system 100 includes terrestrial aspects, such as ground-based network entities, and non-terrestrial aspects, such as satellite and aircraft, which may include network entities on-board (e.g., one or more BSs) capable of communicating with other network elements (e.g., terrestrial BSs) and UEs.

Links 105 in FIG. 1 are air interfaces/radio interface between base stations 104 and user equipment 101. System 100 may subdivide the electromagnetic spectrum into various classes, licensed or unlicensed operating bands, frequency ranges, component carriers, or channels, which define associated frequencies available for communications. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7.125 GHz, which is often referred to (interchangeably) as “Sub-6 GHz”; FR3 as including frequency resources between 7.125 GHz and 24.25 GHz; and F2 as including 24.25 GHz-71.00 GHz, which is sometimes referred to (interchangeably) as a “millimeter wave” (“mmW” or “mmWave”). In some cases, FR2 may be further defined in terms of sub-ranges, such as a first sub-range FR2-1 including 24.25 GHz-52.60 GHz and a second sub-range FR2-2 including 52.60 GHz-71.00 GHz (also referred to as FR4). Communications above the upper frequency band (such as between mmW and THz frequencies, between 100 GHz and 1 THz) may be referred to as sub-Terahertz (sub-THz) communication, for example, including FR5 (114.25 GHz through 300 GHz).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A user equipment 101 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a base station 101 transmitting downlink control information (DCI) to the one or more user equipment 101) or reconfigured (for example, in real-time or near-real-time) according to changing network conditions in system 100 or specific requirements of one or more user equipment 101. An active BWP defines the operating bandwidth of the UE 104 within the operating bandwidth of the serving cell.

The communications links 105 between base station 104 and, for example, user equipment 101, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

User equipment 101, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. User equipment 101 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

A network entity may support wireless communication in accordance with one or more coverage areas, and may be referred to as a network element, a network node, a RAN node, or network equipment, among other nomenclature.

One or more of the network entities may include or may be referred to as a base station 104. Depending on its capabilities, a base station 104 may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, an access point, a base transceiver station, radio BS, radio transceiver, transceiver function, a transmission reception point, or other suitable terminology. System 100 further includes a Wi-Fi access point (AP) in communication with Wi-Fi stations (STAs) via communications links in, for example, a 2.4 GHz and/or 5 GHz unlicensed frequency spectrum.

In one or more aspects, base stations 104 can transmit (“broadcast”) the PRS to user equipment 101 on the downlink radio interfaces 105. The “broadcasting” can be that PRSs are transmitted in a way that allows multiple user equipment 101 in the coverage area to receive them simultaneously, enabling all UEs 101 capable of receiving PRS signals to potentially detect and use them for positioning purposes. PRSs can be transmitted in a coordinated manner among multiple cells. This coordination can involve a concept called “muting,” where cells take turns transmitting PRS to avoid interference from adjacent cells. PRS has a high resource element (RE) density and better correlation properties compared to existing reference signals. Thus, it can be specifically designed for specific positioning use cases and is used by user equipment 101 to detect signals from multiple base stations 104 for accurate position estimation.

In various aspects, a network entity or network node can be implemented as an aggregated BS, as a disaggregated BS, a component of a BS, an integrated access and backhaul (IAB) node, a relay node, a sidelink node, to name a few examples. Wireless backhaul, midhaul, or fronthaul may be implemented via one or more IAB nodes, which may act as a relay using resources of an IAB donor network entity. The system 100 may include one or more of a relay that may steer or reflect signals transmitted by other entities, which may support any of the described communication links.

In one or more aspects, UEs 101 can receive PRS from one or multiple base stations 104 or from one or multiple cells in the vicinity. It is noted that the term base station and cell 101 can be used interchangeably herein. In one or more aspects, UEs 101 can measure the following parameters from the received PRS signals: downlink PRS reference signal received power (DL-PRS-RSRP); DL RS time difference (DRTD); time of arrival (TOA); phase of arrival (POA); and code phase. In one or more aspects, DL-PRS-RSRP is the primary measurement made by UEs from PRS signals and can be used for positioning methods such as DL angle of departure (DL-AoD), DL time different of arrival (DL-TDOA), and Multi-RTT (round trip time). Other parameters can also be used for different methods and combinations of methods. Similar measurements can be performed by base stations 104 using radio interface 105 uplink sounding reference signal (SRS) for positioning purposes.

One or more of the network entities may include the access mobility management functions (AMFs) 108, unified data management (UDM) entity 102, location management functions (LMFs) 107, and other entities (not shown) such as session management functions (SMFs), policy control functions (PCFs), etc. PRS is a signal carried and handled by the link 105 (e.g., air interface) between base station 104 and user equipment or user device 101. User equipment 101 measurement reports are also carried and handled via air interfaces.

In one or more aspects, an LMF 107 receives measurements and assistance information from the 5G base stations 104 and the mobile device or user equipment 101 via the AMF 108 over the NLs interface (not shown here) to compute the position of the user equipment 101. A new NR Positioning Protocol A (NRPPa) was introduced to carry the positioning information between NG-RAN and LMF over the next-generation control plane interface (NG-C) 109. These additions in the 5G architecture provide the framework for positioning in 5G cellular system. The LMF 107 configures the user equipment 101 using the LTE Positioning Protocol (LPP) via AMF 108—via the interface 106. LPP protocols can also be used for the LMF 107 to provide the user equipment 101 with assistance information and to exchange certain information related to positioning between user equipment 101, and LMF 107. The NG-RAN or base station 104 configures the user equipment 101 using the Radio Resource Control (RRC) protocol over the air interfaces. UDM 102 is used to store user equipment subscriber information. The gateway mobile location center (GMLC) 103 provides the functionality required to support location-based services (LBS) and interfaces to location clients (not shown here) outside of the cellular system.

### Aspects Related to Acquisition of Positioning Reference Signals for Device Groups

In one or more aspects, NR PRS in the downlink of radio interface 105 and SRS for positioning in the uplink of the radio interface 105 are used. PRS supports downlink-based positioning. PRS is specifically designed to deliver the highest possible levels of accuracy, coverage, and interference avoidance and suppression. NR PRS has a large delay spread range, as it can be received from potentially distant neighbouring base stations for position estimation. The large delay spread is achieved by covering the whole NR/5G bandwidth and transmitting PRS over multiple symbols that can be aggregated to accumulate power. The density of subcarriers occupied in a given PRS symbol is referred to as the comb size. Each base station 104 can then transmit in different sets of subcarriers to avoid interference. Several base stations 104 can transmit at the same time without interfering with each other, making this solution latency efficient. It is also possible to mute the PRS signal from one or more base stations 104 at a given time according to a muting pattern, further lowering potential interference. For use cases with higher transmission loss (for example, in macro cell deployments), the PRS can also be configured to be repeated to improve hear ability.

In one or more aspects, PRS has a high resource element (RE) density. PRS is not directed at specific UEs 101 but is transmitted in a way that allows all capable UEs in the area to receive it simultaneously. In one or more aspects, UEs 101 with similar characteristics are grouped together. UEs 101 in the group can wake up simultaneously to process PRS and make measurements. One way to achieve this can be to assign the same discontinuous reception (DRX) cycle or enhanced DRX (eDRX) cycle to the UEs 101 in the group.

In one or more aspects, a master device is assigned to the group. This master device can be one of the UEs 101 in the group or a designated device. One or more of the UEs 101 in the group can be designated as the master. This designation can be either randomly selected or selected by certain algorithms, criteria, or conditions. The master can provide coordination to the UEs 101 in the group by waking up at a certain time to receive PRS signals or by requesting the assignment of certain DRX or eDRX cycles on behalf of the UEs 101 in the group.

In one or more aspects, the master device requests a specific PRS start time and duration and inform the devices in the group. One or more of the devices, or all of the devices, in the group can also set the expected PRS start time and duration, with the master then requesting these on behalf of the group. PRS characteristics can be set by either the devices or the master, and the master can request the set PRS characteristics on behalf of the devices in the group.

In one or more aspects, the master device initiates an on-demand PRS or a PRS request on behalf of the group, with a single request from the master device instead of multiple individual requests from UEs 101 in the group. The LMF 107 can only need to process a single request rather than multiple requests from individual UEs 101. This approach can result in significant savings on radio resources as well as other resources.

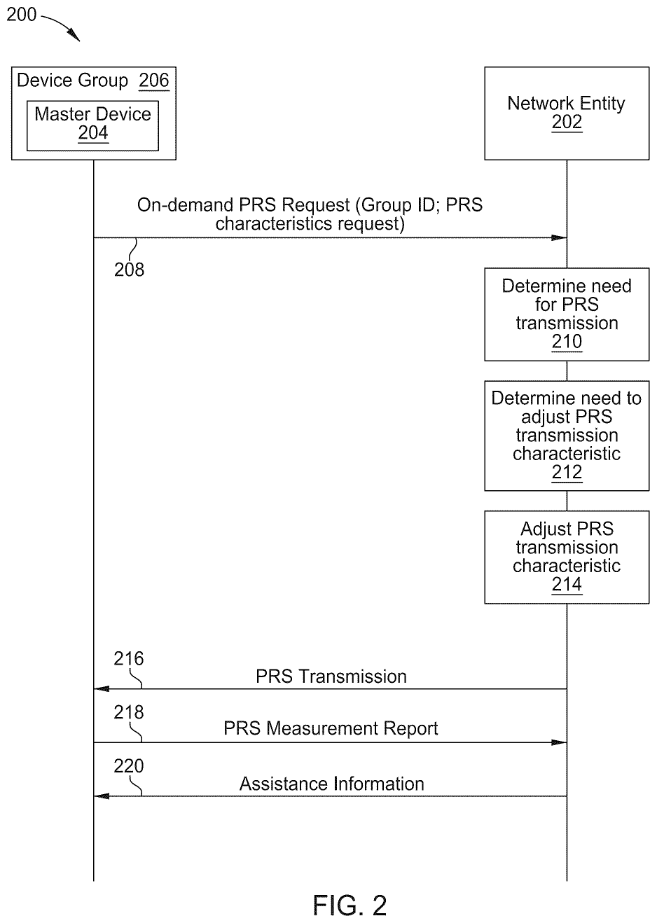

FIG. 2 is a call flow diagram that depicts operations 200 for acquisition of PRS in a network (e.g., system 100) between a network entity 202, a master device 204 (e.g., a UE 101), and other devices in a group of devices 206 with the master device 204.

PRS may not be directed at specific device, but transmitted in a way that allows all capable devices in the area to receive it simultaneously. In one or more aspects, UEs with similar characteristics are grouped together in the group of devices 206. Devices in the group of devices 206 can wake up simultaneously to process PRS and make measurements.

The common characteristics for the group of devices 206 can include the type of devices, such as that all devices in the group of devices 206 are the same type of wearables devices, industrial sensors, or video surveillance cameras. The common characteristics can also be the type of applications used by the devices. The common characteristics can also be all the devices possess the same radio frequency (RF) characteristics. The common characteristics can also be devices that have the same device capabilities. The common characteristics can also be devices that have the same traffic patterns. The common characteristics can also be that all devices are at the same location. The location can be an area covered by one or more base stations/cells 104, or an area pre-defined. For example, all wearable devices can be group together to form the group of devices 206, and the same for industrial sensors or video surveillance cameras. The same applications, such as location-based services and gaming, can also be grouped together to form the group of devices 206.

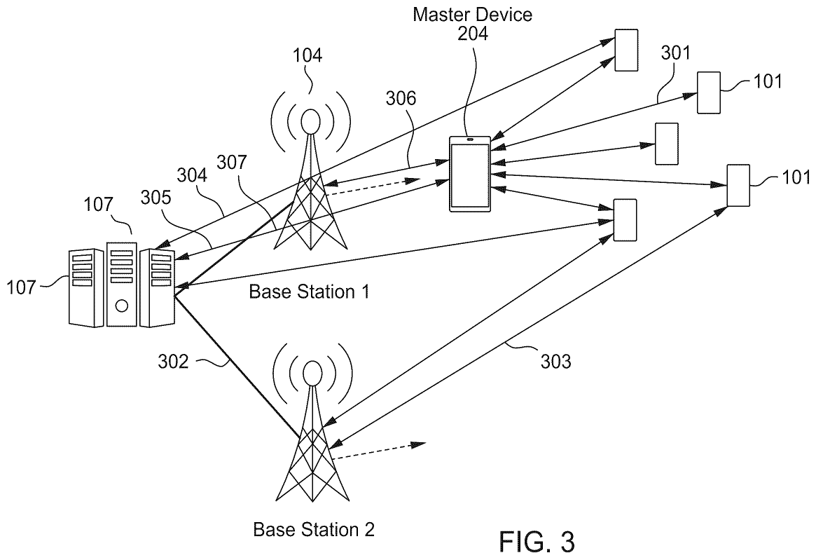

FIG. 3 depicts virtual connections among entities. The master device 204 can be any of the UEs 101 or can be a designated device. The master device 204 can virtually connect to all UEs 101 in the group of devices 206, to the LMF 107, and to base station(s) 104. The master device 204 can send an on-demand request to the LMF 107 via the connection 106 using the LPP protocol on behalf of the UEs 101 in the group of devices 206. The LMF 107 can then send assistance data directly to the UEs 101 via its direct connections 106 using the LPP protocol, or indirectly to the master device 204 which can then distribute the data. Base station(s) 104 can communicate with the master device 204 via a connection 104 and with UEs 101 via connections 104 for various purposes. All these aspects are for illustration purposes; other combinations and/or alternatives are possible. Link 301 is a connection between the master device 204 and UEs 101.

In one or more aspects, all devices are located in the same area covered by one or more base stations or cells 104 for example in an industrial complex with many industrial sensors being user equipment 101. Sensors 101 can form a group, with a single controlling device acting as the master for these sensors 101. In this example, this controlling device can act as if it is a user equipment 101 shown in FIG. 3. All sensors in the group are connected to this controlling device via link 301. A group ID can be assigned to this group of sensors, with the controlling device as the designated master device 204. Sensors 101 in the group can each have a unique device ID. In one example aspect, the group ID and/or device IDs can be pre-assigned and provisioned in the devices. The network can also store information about the group ID and device IDs and retrieve them as needed. There are various methods for assigning, provisioning, and storing the group ID and device IDs.

In one or more aspects, all devices 101, including the master device 204, can be covered by base stations A and B 101. The sensors might move around the complex and require accurate positioning information either consistently or at random intervals. The positioning requirements can or cannot align with the PRS signals transmitted by base stations A and/or B 104 according to their own schedules. The LMF 107 and base stations A and/or B 104 cannot have prior knowledge of the sensors' positioning requirements. Sensors can initiate on-demand PRS requests when they need updated accurate positioning information. If some or all of the sensors attempt to initiate on-demand PRS requests by sending an on-demand mobile-originated location request (MO-LR) message via connection 106 between the sensors 101 and the LMF 107, there can be a high volume of on-demand messages flooding the LMF 107.

Master device 204 may be assigned to the group of devices 206. Master device 204 can be one of the devices in the group of devices 206 or a designated device. One or more of the devices in the group of devices 206 can be designated as the master device 204. The designation of the master device 204 can be randomly selected or selected by certain algorithms, criteria, or conditions. The master device 204 can provide coordination to the devices in the group of devices 206. In one or more aspects, the master device 204 can coordinate with the sensors 101. Whenever one or more sensors, or all sensors 101, have on-demand positioning requirements, the master device 204 can act on their behalf.

In one or more aspects, involves IoT devices as user equipment 101 deployed for agricultural applications. These devices can be covered by many base stations or cells 104 across large areas or covered by drones acting deployed as floating base stations or covered by satellites, or any combination thereof. The IoT devices that use the same application can form a group. Another example can involve a fleet of vehicles. All vehicles in the same fleet can also form a group.

The master device 204 can perform various tasks on behalf of devices in the group of devices 206. One of these tasks can be sending an on-demand PRS request at operation 208. The on-demand PRS request at operation 208 may be an on-demand mobile-originated location request (MO-LR) message, or a location service request message.

The master device 204 can initiate an on-demand PRS request by sending a single MO-LR message on behalf of the sensors 101 in the group via connection 106 between the master 101 and the LMF 107. A single on-demand PRS request message can contain the group ID. The device IDs can or cannot be included in the request message depending on a specific implementation. The LMF 107 can be able to retrieve the group ID and/or device IDs from the message itself. Alternatively, the LMF 107 can retrieve device IDs associated with the group ID from a storage in the network. With the group ID and/or device IDs, the LMF 107 can be able to look up the relevant coverage areas and/or relevant base stations or cells that cover the sensors.

For example, the on-demand MO-LR message can be used by the master device 204 to initiate a PRS request. The master device 204 may send the on-demand PRS request at operation 208 to an LMF (e.g., LMF 107) via an LPP Request Assistance Data message. The on-demand PRS request at operation 208 may request PRS transmission. In this example, the on-demand PRS request at operation 208 is sent by the master device 204 on behalf of one or more devices in the group of devices 206. Otherwise, each of these devices will initiate the request individually as needed. This results in a single request from the master device 204 rather than multiple similar or duplicate requests from each of these devices in the group of devices 206. The LPP Request Assistance Data message sent by the master device 204 can contain a group identification (group ID) indicating which group of devices 206 the request is from and for.

In one or more aspects, Table 1 depicts a header of an example LPP Request Assistance Data message at operation 208.

TABLE 1
LPP Message Header

-- ASN1START
LPP-Message ::= SEQUENCE {
transactionID LPP-TransactionID OPTIONAL, -- Need ON

| | | |
|---|---|---|
| endTransaction | BOOLEAN, | |
| sequenceNumber | SequenceNumber | OPTIONAL, -- |
| Need ON | | |
| acknowledgement | Acknowledgement | OPTIONAL, -- |
| Need ON | | |
| lpp-MessageBody | LPP-MessageBody | OPTIONAL -- |
| Need ON | | |

```
}
SequenceNumber ::= INTEGER (0..255)
Acknowledgement ::= SEQUENCE {
  ackRequested BOOLEAN,
  ackIndicator SequenceNumber OPTIONAL
}
-- ASN1STOP
```

As shown in the Table 1, the transaction ID may carry an LPP-TransactionID.

In one or more aspects, Table 2 depicts a TransactionID.

TABLE 2
TransactionID

```
-- ASN1START
LPP-TransactionID ::= SEQUENCE {
  initiator Initiator,
  groupID BOOLEAN [yes/no] OPTIONAL
  transactionNumber TransactionNumber,
  ...
}
Initiator ::= ENUMERATED {
  locationServer,
  targetDevice,
  ...
}
TransactionNumber ::= INTEGER (0..255)
-- ASN1STOP
```

As shown in the Table 2, the LPP-TransactionID identifies a particular LPP transaction and the initiator of the transaction inside a LPP Request Assistance Data message body. In this example, the transactionID can be used to identify the group of devices 206 or the master device 204. That is, the initiator can be set as the group of devices 206 identified by an ID or other specific form, and the initiator can be the master device 204.

Alternatively, in one or more aspects, there is an optional indicator field as an additional element, groupID, which is a Boolean Yes/No field. The optional indicator field indicates whether the transaction is for a group with a groupID on behalf of the one or more devices in the group. With this indication, the LMF or a location server can readily recognize that the request is from the master device 204 of the group of devices 206 on behalf of one or more devices in the group of devices 206. If this field is absent or no, the LMF can either treat the request as coming from a regular device, or unless it is recognized from the initiator that the request is from a master device 204 for the group of devices 206.

One or more aspects, as shown in Table 3, the initiator is explicitly set to the groupID, which contains one or more device IDs in the group of devices 206. The group ID can be pre-assigned or can simply serve as the identification for the master device 204. The group ID can be known to the LMF or location server.

TABLE 3
Initiator set to GroupID

```
-- ASN1START
LPP-TransactionID ::= SEQUENCE {
  initiator GroupID,
  transactionNumber TransactionNumber,
  ...
}
GroupID ::= ENUMERATED {
  locationServer,
  {targetDevice1,targetDevice2, ... targetDeviceN}
  ...
}
TransactionNumber ::= INTEGER (0..255)
-- ASN1STOP
```

NR-On-Demand-DL-PRS-Request or the IE NR-On-Demand-DL-PRS-Request in the request message can be used by a target device to request on-demand DL-PRS from a location server or LMF, shown in the Table 4.

TABLE 4
On-demand request IE

```
-- ASN1START
NR-On-Demand-DL-PRS-Request-r17 ::= SEQUENCE {
dl-prs-StartTime-and-Duration-r17 DL-PRS-StartTime-and-Duration-
r17 OPTIONAL,
nr-on-demand-DL-PRS-Information-r17 NR-On-Demand-DL-PRS-
Information-r17 OPTIONAL,
dl-prs-configuration-id-PrefList-r17 SEQUENCE (SIZE (1..maxOD-DL-PRS-Configs-
r17)) OF
...,
[[
dl-PRS-AggregationID-PrefList-r18 SEQUENCE (SIZE (1..maxOD-DL-PRS-
Configs-r17)) OF
INTEGER (1..maxOD-DL-PRS-Configs-
r17)
  OPTIONAL,
nr-OnDemandDL-PRS-AggregationReqList-r18 SEQUENCE (SIZE (1..maxOD-DL-
PRS-Configs-r17)) OF
NR-OnDemandDL-PRS-AggregationReqElement-
r18
  OPTIONAL
]]
}
DL-PRS-StartTime-and-Duration-r17 ::= SEQUENCE {
dl-prs-start-time-r17 INTEGER
(1..1024) OPTIONAL,
dl-prs-duration-r17  SEQUENCE {
seconds-r17  INTEGER (0..59)  OPTIONAL,
minutes-r17  INTEGER (0..59)  OPTIONAL,
hours-r17  INTEGER (0..23)  OPTIONAL,
...
} OPTIONAL,
...
}
NR-OnDemandDL-PRS-AggregationReqElement-r18 ::= SEQUENCE (SIZE (2..3)) OF
INTEGER (1..nrMaxFreqLayers-r16)
-- ASN1STOP
```

In one or more aspects, the on-demand PRS request at operation 208 can include the PRS starting time and duration. One or more aspects involves the master device 204 coordinating with all or some of the devices in the group of devices 206 which want to receive the PRS signals. One or more of the devices, or all of the devices, in the group of devices 206 can also set the expected PRS start time and duration, with the master device 204 then requesting these on behalf of the group of devices 206. PRS characteristics can be set by either the devices or the master device 204, and the master device 204 can request the set PRS characteristics on behalf of the devices in the group.

In one or more aspects, the on-demand mobile-originated location request (MO-LR) message, or a location service request message, at operation 208, can include any of the following request types: a request for a pre-defined PRS configuration indicated by a pre-defined PRS configuration ID or explicit parameters for PRS configuration, and a request for PRS transmission or changes to the PRS transmission characteristics for positioning measurements (e.g. one or more positioning measurements). One of these messages can also include PRS configuration details, which might include measurement gaps, PRS processing windows, or resource allocations. Measurement gaps are the time periods during which the UE can perform the specified measurements, such as PRS measurements. The PRS processing window is used by the base stations to provide a PRS processing window for NR DL-PRS measurements to the UE 101 without a measurement gap. The master device 204 can also use one of these request messages to request the LMF to make changes to PRS configurations, such as adjusting any configured (e) DRX settings by specifying the parameters for the PRS configuration accordingly.

As shown in FIG. 2, at operation 212, the network entity 202 (e.g., a base station) may determine the need to adjust a PRS transmission characteristic.

In one or more aspects, the network entity 202 receives and processes a request message from the master device 204. In some aspects, the request can be one of the following: IE=NR-On-Demand-DL-PRS-Configurations; IE=NR-On-Demand-DL-PRS-Information; IE=NR-On-Demand-DL-PRS-Configurations-Selected-IndexList; IE=NR-On-Demand-DL-PRS-Support; Or others.

The master device 204 may send an On-Demand PRS request to the LMF 107 or a location server via the LPP protocol for PRS transmission on behalf of the devices 101 in the group. While the LMF 107 is used in the following examples, similar principles can apply to location servers and/or base stations 104. The request can be an NR-On-Demand-DL-PRS-Request message sent from the master device 204 to the LMF 107. Upon receiving this message, the LMF 107 processes the request. As shown in the Table 4, the body of the request message may include IE-NR-On-Demand-DL-PRS-Request that indicates that the master device 204 is requesting downlink PRS on behalf of the devices in the group of device 206 by specifying the group ID contained in the header of the request message.

In one or more aspects, the group ID can be the transaction ID itself. That is the transaction ID in the header of the message can be set to the groupID, with the initiator set as the master device as shown in the Table 1 and Table 2. In one example aspect, the message contains each device's ID of the devices in the group of devices 206. For example, as shown in the Table 3, the groupID field may contain all the device IDs in the group of devices 206, or just the device IDs of those devices wishing to receive PRS signals. The group ID is recognized or determined by the LMF 107. This recognition or determination can be achieved in several ways. For instance, the group ID can be assigned and stored as a subscriber ID, with or without any special marking. Alternatively, it can be assigned as a special node with a unique ID. These examples are for illustration purposes only, and different methods or combinations thereof can be used. The device ID can be a standard subscriber ID for the device or another assigned ID. The request message can or cannot need to include these device IDs. The LMF 107 can recognize them as part of the group associated with the group ID.

In one or more aspects, the NR-On-Demand-DL-PRS-Request message can contain elements such as DL-PRS-StartTime-and-Duration, among others. In this example, the master device 204 requests when PRS signals should be transmitted and for how long. Upon receiving the request, the LMF 107 processes the information contained in the request message. The LMF 101 uses this information to prepare instructions for the relevant base stations 104 or other related transmission and reception points.

In one or more aspects, the LMF sends a PRS configuration request to the relevant serving base stations. If the devices in the group of devices 206 share the same coverage area provided by the same base station(s) or cells, these devices can receive PRS signals transmitted by the same base station(s) or cells at approximately the same time. With a single request from the master device 204, the LMF can process this single request. The LMF can then send instructions to the relevant base stations to carry out the necessary tasks and transmit the PRS signals.

In one or more aspects, the LMF 107 receives a message with an IE=NR-On-Demand-DL-PRS-Request and determines that it is a request for PRS transmission. The LMF 107 then initiates the procedure by sending PRS CONFIGURATION REQUEST messages to the relevant base stations or cells 104 via the Positioning Protocol Annex (NRPPa) protocol. In the PRS CONFIGURATION REQUEST message, the PRS Configuration Request Type IE is set to “configure.”

As shown in FIG. 2, at operation 214, the network entity 202 adjusts the transmission characteristic based on the determination at operation 212. The base stations (or cells) 104 will use the information in the Requested DL PRS Transmission Characteristics IE to configure the DL-PRS transmission. The DL PRS Transmission Characteristics can include parameters such as PRS starting time, duration, and other resource allocation details.

As shown in FIG. 2, at operation 216, the network entity 202 transmits PRS based on the PRS transmission characteristics to at least one device in the group of devices 206. In one or more aspects, upon successful completion of PRS configuration after receiving the request message from the LMF 107, the base stations or cells 104 begin transmitting PRS signals for the requested duration.

As shown in FIG. 2, at operation 218, the at least one device in the group of devices 206 can receives, process, and measure the PRS. Based on the measurements, the device in the group of devices 206 may sends one or more PRS measurements to the network entity 202. All devices that wish to receive and process the PRS signals start making measurements. Various positioning calculation algorithms can be used to perform positioning calculations. Measurements are collected across one or multiple resources and resource sets as base stations transmit PRS via one or more resources and/or resource sets using RF transmission beams. Beamforming enhances the signal-to-noise ratio (SNR) due to beamforming gain and provides the UE 101 with location information in terms of the angle of departure (AOD) based on the beam ID accessed by the UE 101. Many of these measurements are standardized to support a variety of positioning methods: for example, the observed time difference of arrival (OTDOA) method, the uplink time difference of arrival (UL-TDOA) method, and the positioning methods that are based on power measurements. Additional methods can also be used, for example the round-trip time (RTT) method and the angle-based positioning method. Devices can provide the LMF 107 with reports on their measurements and other information.

As shown in FIG. 2, at operation 220, the network entity 202 may send assistance information to the device in the group of devices 206 based on the one or more PRS measurement reports. Based on the reports and/or other factors, the LMF 107 can perform or update positioning calculations for the devices 101 and provide them with assistance data.

In one or more aspects, in the example of sensors 101 in an industry complex, upon receiving the on-demand PRS request from the controlling device (the master device 204), and after the procedures between the LMF 107 and base stations (or cells) 104 discussed above, the sensors can now receive PRS signals transmitted from stations A and B 104 and make measurements. The sensors can send their measurement reports to the LMF 107 via direct connections 304 individually. Alternatively, the master device 204 can collect measurement results from individual sensors and send the reports to the LMF 107 on behalf of the sensors, or a combination of these approaches. The LMF 107 can then provide assistance data either directly to the sensors or via the master device 204, or through a combination of both methods, and/or other methods. In the example of the industry complex sensors, the controlling device 101 acting as the master device 204 coordinates with the sensors on the configuration parameters. The master device 204 then sends updates or changes to the configuration characteristics on behalf of the sensors in the group. The sensors in the group of devices 206 are synchronized with the master device 204 and with the LMF 107/base stations 104 regarding PRS signal transmission and reception.

### Example Operations of a Master Device

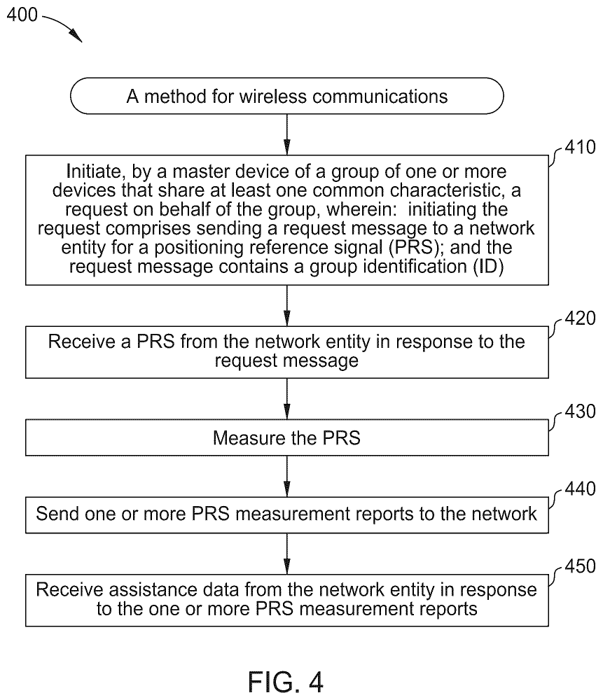

FIG. 4 shows a method 400 for wireless communications by a mater device.

Method 400 begins at operation 410 with initiating, by a master device of a group of one or more devices that share at least one common characteristic, a request on behalf of the group. Initiating the request at operation 410 may include sending a request message to a network entity for a positioning reference signal (PRS). The request message may contains a group identification (ID).

In one aspect, the request message requests transmission of the PRS.

In one aspect, the request message requests a change or update of a transmission characteristic of the PRS.

In one aspect, method 400 further includes, at operation 420, receiving a PRS from the network entity in response to the request message.

In one aspect, method 400 further includes measuring the PRS, at operation 430, and sending one or more PRS measurement reports to the network at operation 440.

In one aspect, method 400 further includes, at operation 450, receiving assistance data from the network entity in response to the one or more PRS measurement reports.

In one aspect, the at least one common characteristic comprises at least one of: a type of the one or more devices, a type of one or more applications associated with the one or more devices, one or more radio frequency characteristics associated with the one or more devices, one or more capabilities of the one or more devices, one or more traffic patterns of the one or more devices, or one or more locations of the one or more devices.

In one aspect, the type of the one or more devices comprises at least one of: wearable devices, industrial sensors, or video surveillance cameras.

In one aspect, the one or more locations of the one or more devices comprises the one or more locations of the one or more devices being covered by at least one of: one or more base stations, one or more cells, or a pre-defined area.

In one aspect, the request message is an on-demand mobile-originated location request (MO-LR) message.

In one aspect, the MO-LR message includes a request for a PRS configuration.

In one aspect, the request for the PRS configuration includes at least one of: a PRS configuration ID of a predefined PRS configuration.

In one aspect, the request for the PRS configuration includes one or more explicit requested parameters for the PRS configuration.

In one aspect, the request message is a location service request message.

In one aspect, the request message further contains an indication that the request message is from the master of the group on behalf of the group.

In one aspect, the request message further comprises an ID of each of the one or more devices.

In one aspect, the request message is an on-demand downlink PRS request (NR-On-Demand-DL-PRS-Request).

In one aspect, the request message further contains a requested start time and a requested duration of the PRS transmission.

In one aspect, the master device is assigned by: a fixed assignment, a random selection, a rotating assignment, or a designated device.

In one aspect, the network entity is a base station.

In one aspect, the network entity is a location management function (LMF).

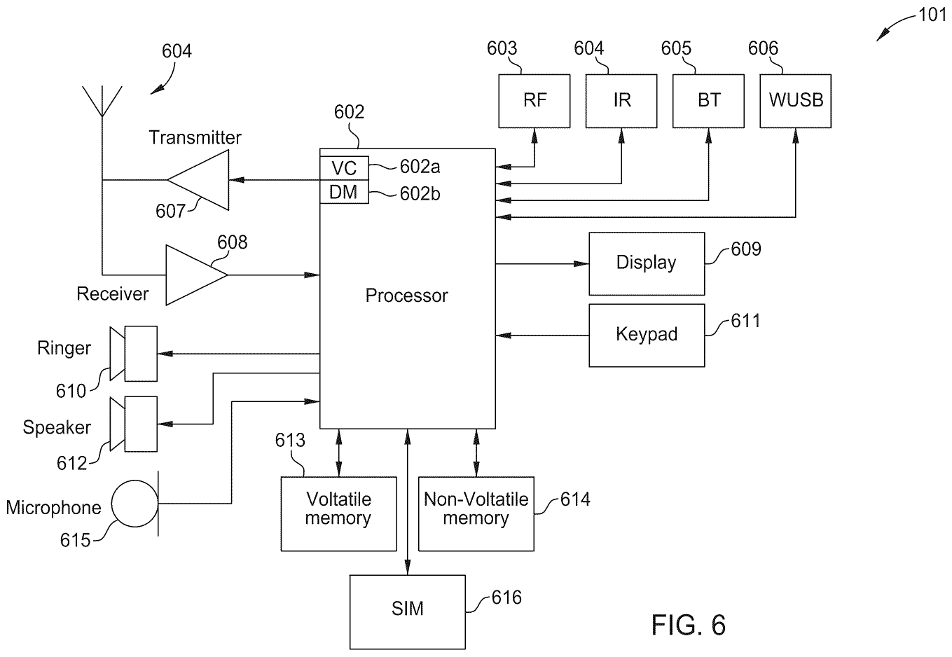

In one aspect, method 400, or any aspect related to it, may be performed by an apparatus, such as the UE of FIG. 6, which includes various components operable, configured, or adapted to perform the method 400.

Note that FIG. 4 is just one example of a method, and other methods including fewer, additional, or alternative steps are possible consistent with this disclosure.

### Example Operations of a Network Entity

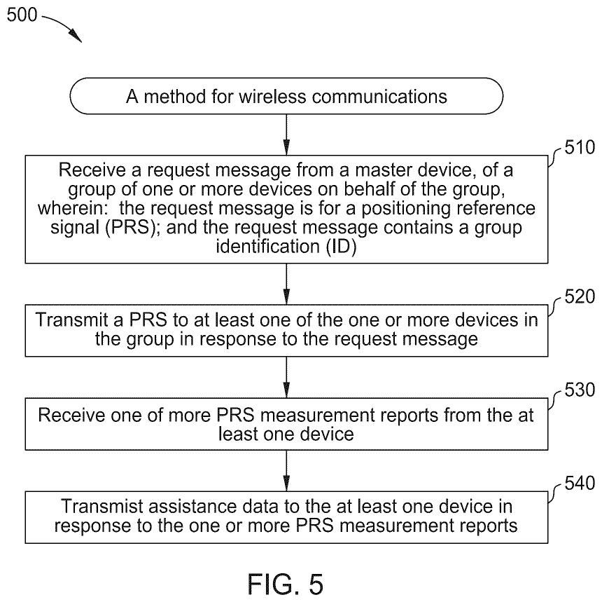

FIG. 5 shows a method 500 for wireless communications by a network entity.

Method 500 begins at 510 with receiving a request message from a master device, of a group of one or more devices, on behalf of the group. The request message contains a group identification (ID) of the group, and the request message is for a positioning reference signal (PRS).

Method 500 then proceeds to step 520 with transmitting a PRS to at least one of the one or more devices in the group in response to the request message.

In one aspect, an ID of each of the one or more devices of the group are pre-stored at the network entity.

In one aspect, the request message requests transmission of the PRS.

In one aspect, the request message requests a change or update of a transmission characteristic of the PRS.

In one aspect, method 500 further includes receiving, at operation 530, one or more PRS measurement reports from the at least one device.

In one aspect, method 500 further includes transmitting, at operation 540, assistance data to the at least one device in response to the one or more PRS measurement reports.

In one aspect, the group of device share at least one common characteristic, the at least one common characteristic comprising at least one of: a type of the one or more devices, a type of one or more applications associated with the one or more devices, one or more radio frequency characteristics associated with the one or more devices, one or more capabilities of the one or more devices, one or more traffic patterns of the one or more devices, or one or more locations of the one or more devices.

In one aspect, the type of the one or more devices comprises at least one of: wearable devices, industrial sensors, or video surveillance cameras.

In one aspect, the one or more locations of the one or more devices comprises the one or more locations of the one or more devices being covered by at least one of: one or more base stations, one or more cells, or a pre-defined area.

In one aspect, the request message is an on-demand mobile-originated location request (MO-LR) message.

In one aspect, the MO-LR message includes a request for a PRS configuration.

In one aspect, the request for the PRS configuration includes at least one of: a PRS configuration ID of a predefined PRS configuration.

In one aspect, the request for the PRS configuration includes one or more explicit requested parameters for the PRS configuration.

In one aspect, the request message is a location service request message.

In one aspect, the request message further contains an indication that the request message is from the master of the group on behalf of the group.

In one aspect, the request message further comprises an ID of each of the one or more devices.

In one aspect, the request message is an on-demand downlink PRS request (NR-On-Demand-DL-PRS-Request).

In one aspect, the request message further contains a requested start time and a requested duration of the PRS transmission.

In one aspect, the master device is assigned by: a fixed assignment, a random selection, a rotating assignment, or a designated device.

In one aspect, the network entity is a base station.

In one aspect, the network entity is a location management function (LMF).

In one aspect, method 500 further includes transmitting a PRS configuration request, the PRS configuration request initiating a PRS configuration exchange procedure.

### Example Communications Devices

FIG. 6 illustrates a block diagram of an apparatus 101 such as, for example, a mobile terminal, a user equipment or a reduced capability (RedCap) or IoT device, in accordance with one or more aspects of the present disclosure. While several features of the apparatus 101 are illustrated and will be hereinafter described for purposes of example, other types of electronic devices, such as mobile telephones, mobile computers, tablet computers, phablet devices, portable digital assistants, PDAs, pagers, laptop computers, desktop computers, gaming devices, televisions, routers, home gateways, and other types of electronic systems, can employ various aspects of the disclosure.

As shown, in one or more aspects per the present disclosure, the mobile terminal 101 can include at least one antenna 601 in communication with a transmitter 607 and a receiver 608. Alternatively transmit and receive antennas can be separate. The mobile terminal 101 can also include a processor 602 configured to provide signals to and receive signals from the transmitter and receiver, respectively, and to control the functioning of the apparatus. Processor 602 can be configured to control the functioning of the transmitter and receiver by effecting control signaling via electrical leads to the transmitter and receiver. Likewise, processor 602 can be configured to control other elements of apparatus 101 by effecting control signaling via electrical leads connecting processor 602 to the other elements, such as for example a display or a memory. Processor 602 can, for example, be configured to receive information A via said electrical leads, and to at least in part perform X on information A to yield information B. Processor 602 can transmit information B via said electrical leads to transmitter 607.

The processor 602 can, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit, ASIC, or field programmable gate array, FPGA, or some combination thereof. A processor including exactly one processing core can be referred to as a single-core processor, while a processor including more than one processing core can be referred to as a multi-core processor. Accordingly, although illustrated in FIG. 6 as a single processor, in some aspects, the processor 602 includes a plurality of processors or processing cores.

Signals sent and received by the processor 602 can include signaling information in accordance with an air interface standard of an applicable cellular system, and/or any number of different wireline or wireless networking techniques, including but not limited to Wi-Fi, wireless local access network, WLAN, techniques such as Institute of Electrical and Electronics Engineers, IEEE, 802.11, 802.16, and/or the like. In addition, these signals can include speech data, user generated data, user requested data, and/or the like. In this regard, the apparatus can be capable of operating with one or more air interface standards, communication protocols, modulation types, access types, and/or the like.

More particularly, the apparatus can be capable of operating in accordance with various first generation, 1G, second generation, 2G, 2.5G, third-generation, 3G, communication protocols, fourth-generation, 4G, fifth-generation, 5G, sixth-generation, 6G, communication protocols, Internet Protocol Multimedia Subsystem, IMS, communication protocols, for example, session initiation protocol, SIP, and/or the like. For example, the apparatus can be capable of operating in accordance with 2G wireless communication protocols IS-136, Time Division Multiple Access TDMA, Global System for Mobile communications, GSM, IS-95, Code Division Multiple Access, CDMA, and/or the like. Also, for example, the mobile terminal can be capable of operating in accordance with 2.5G wireless communication protocols General Packet Radio Service. GPRS, Enhanced Data GSM Environment, EDGE, and/or the like. Further, for example, the apparatus can be capable of operating in accordance with 3G wireless communication protocols such as Universal Mobile Telecommunications System, UMTS, Code Division Multiple Access 2000, CDMA2000, Wideband Code Division Multiple Access, WCDMA, Time Division-Synchronous Code Division Multiple Access, TD-SCDMA, and/or the like. The apparatus can be additionally capable of operating in accordance with 3.9G wireless communication protocols such as Long Term Evolution, LTE, or Evolved Universal Terrestrial Radio Access Network, E-UTRAN, and/or the like. Additionally, for example, the apparatus can be capable of operating in accordance with fourth-generation, 4G, 5G, or 6G, wireless communication protocols such as LTE Advanced and/or the like as well as similar wireless communication protocols that can be developed in the future. Apparatus 101 can include a graphics processor.

In one or more aspects, Narrow-band Advanced Mobile Phone System, NAMPS, as well as Total Access Communication System, TACS, mobile terminal apparatuses can also benefit from the one or more aspects of this disclosure, as should dual or higher mode phone apparatuses, for example, digital/analogue or TDMA/CDMA/analogue phones. Additionally, apparatus 101 can be capable of operating according to Wi-Fi or Worldwide Interoperability for Microwave Access, WiMAX, and protocols.

In one or more aspects, it is understood that the processor 602 can include circuitry for implementing audio/video and logic functions of apparatus 101. For example, the processor 602 can include a digital signal processor device, a microprocessor device, an analogue-to-digital converter, a digital-to-analogue converter, and/or the like. Control and signal processing functions of the mobile terminal can be allocated between these devices according to their respective capabilities. The processor can additionally include an internal voice coder, VC, 602a, an internal data modem, DM, 602b, and/or the like. Further, the processor can include functionality to operate one or more software programs, which can be stored in memory. In general, processor 602 and stored software instructions can be configured to cause apparatus 101 to perform actions. For example, processor 602 can be capable of operating a connectivity program, such as a web browser. The connectivity program can allow the mobile terminal 101 to transmit and receive web content, such as location-based content, according to a protocol, such as wireless application protocol, WAP, hypertext transfer protocol, HTTP, and/or the like

In one or more aspects, apparatus 101 can also include a user interface including, for example, an earphone or speaker 612, a ringer 610, a microphone 615, a display 609, a user input interface, and/or the like, which can be operationally coupled to the processor 602. Apparatus 101 can include a stereo microphone. Apparatus 101 can include at least one camera. In this regard, the processor 602 can include user interface circuitry configured to control at least some functions of one or more elements of the user interface, such as, for example, the speaker 612, the ringer 610, the microphone 615, the display 609, and/or the like. The processor 602 and/or user interface circuitry including the processor 602 can be configured to control one or more functions of one or more elements of the user interface through computer program instructions, for example, software and/or firmware, stored on a memory accessible to the processor 602, for example, volatile memory 613, non-volatile memory 614, and/or the like. Although not shown, the apparatus can include a battery for powering various circuits related to the mobile terminal, for example, a circuit to provide mechanical vibration as a detectable output. The user input interface can include devices allowing the apparatus to receive data, such as a keypad 611, a touch display, which is not shown, a joystick, which is not shown, and/or at least one other input device. In aspects including a keypad, the keypad can include numeric 0-9 and related keys, and/or other keys for operating the apparatus.

In one or more aspects, as shown in FIG. 6, apparatus 101 can also include one or more means for sharing and/or obtaining data. For example, the apparatus can include a short-range radio frequency, RF, transceiver and/or interrogator 603 so data can be shared with and/or obtained from electronic devices in accordance with RF techniques. The apparatus can include other short-range transceivers, such as, for example, an infrared, IR, transceiver 604, a Bluetooth™, BT, transceiver 605 operating using Bluetooth™ brand wireless technology developed by the Bluetooth™ Special Interest Group, a wireless universal serial bus, USB, transceiver 606 and/or the like. The Bluetooth™ transceiver 605 can be capable of operating according to low power or ultra-low power Bluetooth™ technology, for example, Bluetooth low energy, radio standards. In this regard, the apparatus 101 and, in particular, the short-range transceiver can be capable of transmitting data to and/or receiving data from electronic devices within a proximity of the apparatus, such as within 10 meters, for example. Although not shown, the apparatus can be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

In one or more aspects, the apparatus 101 can include memory, such as a subscriber identity module, SIM, a removable user identity module, R-UIM, and/or the like, which can store information elements related to a mobile subscriber. In addition to the SIM, the apparatus can include other removable and/or fixed memory. The apparatus 101 can include volatile memory 613 and/or non-volatile memory 614. For example, volatile memory 613 can include Random Access Memory, RAM, including dynamic and/or static RAM, on-chip or off-chip cache memory, and/or the like. Non-volatile memory 614, which can be embedded and/or removable, can include, for example, read-only memory, flash memory, magnetic storage devices, for example, hard disks, floppy disk drives, magnetic tape, etc., optical disc drives and/or media, non-volatile random-access memory, NVRAM, and/or the like. Like volatile memory 613, non-volatile memory 614 can include a cache area for temporary storage of data. At least part of the volatile and/or non-volatile memory can be embedded in processor 602. The memories can store one or more software programs, instructions, pieces of information, data, and/or the like which can be used by the apparatus for performing functions of the mobile terminal. For example, the memories can include an identifier, such as an international mobile equipment identification, IMEI, code, capable of uniquely identifying apparatus 101.

In one or more aspects, FIG. 6 is described above primarily in the context of a mobile device, certain of the components discussed, such as memories, processors, and transceivers, can be employed to implement a network-side device.

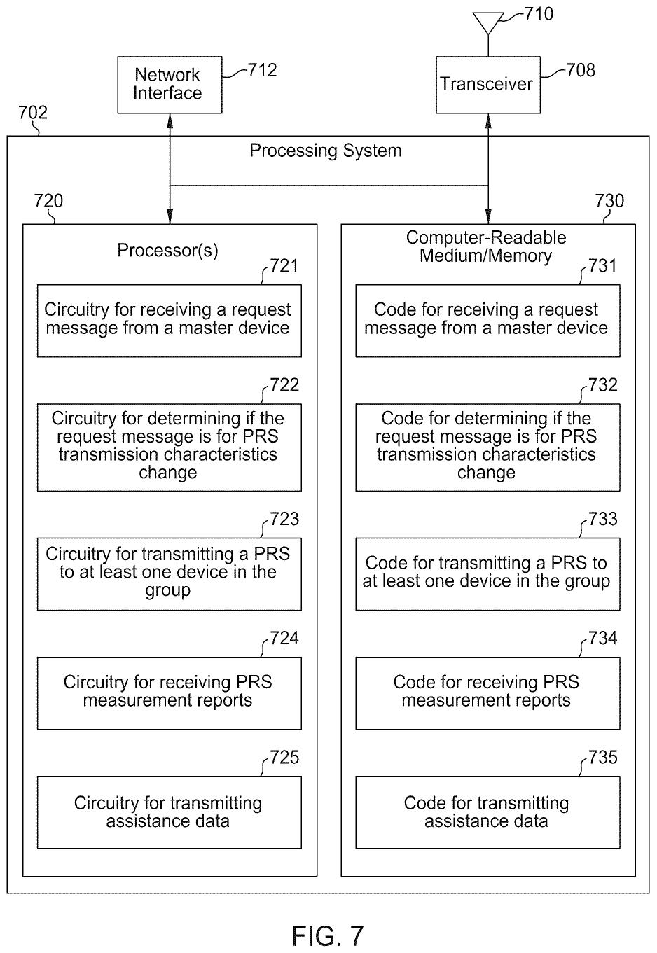

FIG. 7 depicts aspects of an example communications device. In some aspects, communications device 700 is a network entity. Communication device 700 may be capable of transmitting and receiving wireless communications in the form of, for example, wireless packets. For example, communication device 700 may be configurable or configured to transmit and receive signals and communications conforming to one or more 3GPP specifications including those for 5G NR or 6G, among others. Additionally, or alternatively, wireless communication device 700 may be configurable or configured to transmit and receive signals and communications conforming to one or more of the IEEE 802.11 family of wireless communication protocol standards, among others.

The communications device 700 includes a processing system 702 coupled to a transceiver 708 (e.g., a transmitter and/or a receiver) and/or a network interface 712. The transceiver 708 is configured to transmit and receive signals for the communications device 700 via an antenna 710, such as the various signals as described herein. The network interface 712 is configured to obtain and send signals for the communications device 700 via communications link(s), such as a backhaul link, midhaul link, and/or fronthaul link. The processing system 702 may be configured to perform processing functions for the communications device 700, including processing signals received and/or to be transmitted by the communications device 700. The processing system 702 may be configured to perform PHY layer operations and MAC layer operations, and, in some instances, upper layer operations, associated with transmitting and receiving wireless communications.

In some examples, the communication device 700 may also include at least one other external network interface (not shown) that enables the processing system 702 to communicate with another network (such as a core network, a backhaul network) to gain access to external networks including the Internet. For example, a communication device 700 configured as a network entity may include multiple external network interfaces including one or more wired or wireless network interfaces (such as to support a backhaul link).

The processing system 702 includes one or more processors 720. Processing system 702 may include one or more chips, SoCs, chipsets, packages, components or devices that individually or collectively constitute the processing system 702. Processing system 702 may interface with other components of a communication device 700 and may generally process information (such as inputs or signals) received from such other components and output information (such as outputs or signals) to such other components. The one or more processors 720 are coupled to a computer-readable medium/memory 730 via a bus 706. In certain aspects, the computer-readable medium/memory 730 is configured to store instructions (e.g., computer-executable code) that when executed by the one or more processors 720, cause the one or more processors 720 to perform the method 500 described with respect to FIG. 5, or any aspect related to it. Note that reference to a processor of communications device 700 performing a function may include one or more processors of communications device 700 performing that function.

In the depicted example, the computer-readable medium/memory 730 stores code (e.g., executable instructions) for receiving a request message from a master device on behalf of a group 731, code for determining if the request message is for PRS transmission or PRS transmission characteristics change 732, code for transmitting a PRS to at least one device in the group 733, code for receiving PRS measurement reports 734, and code for transmitting assistance data 735. Processing of the code 731-735 may cause the communications device 700 to perform the method 500 described with respect to FIG. 5, or any aspect related to it. Computer-readable medium/memory 730 may be implemented in the form of one or more memory devices, memory components, memory blocks, memory elements or other discrete gate or transistor logic or circuitry. Computer-readable medium/memory 730 may include tangible storage media including non-volatile memory, such as ROM, or volatile memory, such as RAM (such as SRAM), DRAM, or SDRAM such as low power double data rate (LPDDR) memory, among other examples, each of which may be generally referred to herein individually as “a memory” or “memory circuitry”) In some examples, processors 720 may be coupled with memory circuitry outside of or distinct from the processing system 702. For example, such additional memory circuitry may include a non-volatile memory storage device such as a SSD, a HDD, or removable storage media. In some other examples, additional memory circuitry also may include volatile memory such as SRAM, DRAM, SDRAM, LPDDR memory, among other examples.

The one or more processors 720 include circuitry configured to implement (e.g., execute) the code stored in the computer-readable medium/memory 730, including circuitry for receiving a request message from a master device on behalf of a group 721, circuitry for determining if the request message is for PRS transmission or PRS transmission characteristics change 722, circuitry for transmitting a PRS to at least one device in the group 723, circuitry for receiving PRS measurement reports 724, and circuitry for transmitting assistance data 725. Processing with circuitry 721-725 may cause the communications device 700 to perform the method 500 as described with respect to FIG. 5, or any aspect related to it.

The wireless communication device 700 may further include any additional circuitry or components for the processing system 702 to operate to perform the functions and processes described herein. In some examples, the processing system 702 may further include, be coupled with, or be connected to one or more encoding circuits and decoding circuits (also referred to herein simply as “encoders” and “decoders,” respectively), one or more segment parsing circuits and deparsing circuits (also referred to herein simply as “segment parsers” and “segment deparsers,” respectively), one or more stream parsing circuits and deparsing circuits (also referred to herein simply as “stream parsers” and “stream deparsers,” respectively), and modulation circuits and demodulation circuits or circuitry (not specifically shown). For example, the processing system 702 can include one or more modulation circuits and demodulation circuits in the form of one or more modem chips (also referred to herein simply as “modems”), each including processor circuitry configured for performing modulation or demodulation of wireless communication signals, among other functions associated with PHY layer operations.

In some examples, the modem circuitry, whether implemented internal or external to the processing system 702, may further include, be coupled with, or be connected to one or more RF and analog circuits or circuitry (not specifically shown). In some examples in which the processing system 702 includes modem circuitry, the processing system 702 may include at least some of the RF and analog circuitry. In some other examples, most or all of the RF and analog circuitry is separate from but coupled directly or indirectly with or connected to the processing system 702, such as to the modem circuitry. The RF and analog circuitry can include RF chains or transceiver circuitry (or transceivers), which may include one or more filters, mixers, oscillators, amplifiers such as power amplifiers (PAs) or low-noise amplifiers (LNAs), analog-to-digital converters (ADCs), digital-to-analog converters (DACs), power trackers, or other components that process signals including converting them between analog (such as for transmission or reception via an air interface) and digital (such as for processing by the processing system 702) domains.

### EXAMPLE CLAUSES

Implementation examples are described in the following numbered clauses:

Clause 1: A method for wireless communications, the method comprising: initiating, by a master device of a group of one or more devices that share at least one common characteristic, a request on behalf of the group, wherein: initiating the request comprises sending a request message to a network entity for a positioning reference signal (PRS); and the request message contains a group identification (ID).

Clause 2: The method of Clause 1, wherein the request message requests transmission of the PRS.

Clause 3: The method of any combination of Clauses 1-2, wherein the request message requests a change or update of a transmission characteristic of the PRS.

Clause 4: The method of any combination of Clauses 1-3, further comprising receiving a PRS from the network entity in response to the request message.

Clause 5: The method of Clause 4, further comprising: measuring the PRS; and sending one or more PRS measurement reports to the network.

Clause 6: The method of Clause 5, further comprising receiving assistance data from the network entity in response to the one or more PRS measurement reports.

Clause 7: The method of any combination of Clauses 1-6, wherein the at least one common characteristic comprises at least one of: a type of the one or more devices, a type of one or more applications associated with the one or more devices, one or more radio frequency characteristics associated with the one or more devices, one or more capabilities of the one or more devices, one or more traffic patterns of the one or more devices, or one or more locations of the one or more devices.

Clause 8: The method of Clause 7, wherein the type of the one or more devices comprises at least one of: wearable devices, industrial sensors, or video surveillance cameras.

Clause 9: The method of Clause 7, wherein the one or more locations of the one or more devices comprises the one or more locations of the one or more devices being covered by at least one of: one or more base stations, one or more cells, or a pre-defined area.

Clause 10: The method of any combination of Clauses 1-9, wherein the request message is an on-demand mobile-originated location request (MO-LR) message.

Clause 11: The method of Clause 10, wherein the MO-LR message includes a request for a PRS configuration.

Clause 12: The method of Clause 11, wherein the request for the PRS configuration includes at least one of: a PRS configuration ID of a predefined PRS configuration.

Clause 13: The method of Clause 11, wherein the request for the PRS configuration includes one or more explicit requested parameters for the PRS configuration.

Clause 14: The method of any combination of Clauses 1-13, wherein the request message is a location service request message.

Clause 15: The method of any combination of Clauses 1-14, wherein the request message further contains an indication that the request message is from the master of the group on behalf of the group.

Clause 16: The method of any combination of Clauses 1-15, wherein the request message further comprises an ID of each of the one or more devices.

Clause 17: The method of any combination of Clauses 1-16, wherein the request message is an on-demand downlink PRS request (NR-On-Demand-DL-PRS-Request).

Clause 18: The method of any combination of Clauses 1-17, wherein the request message further contains a requested start time and a requested duration of the PRS transmission.

Clause 19: The method of any combination of Clauses 1-18, wherein the master device is assigned by: a fixed assignment, a random selection, a rotating assignment, or a designated device.

Clause 20: The method of any combination of Clauses 1-19, wherein the network entity is a base station.

Clause 21: The method of any combination of Clauses 1-20, wherein the network entity is a location management function (LMF).

Clause 22: An apparatus for wireless communications, the apparatus comprising: memory storing computer executable code; and one or more processors configured to execute the computer executable code to cause the apparatus to: initiate, by a master device of a group of one or more devices that share at least one common characteristic, a request on behalf of the group, wherein: initiating the request comprises sending a request message to a network for a positioning reference signal (PRS); and the request message contains a group identification (group ID).

Clause 23: A method for wireless communications by a network entity, the method comprising: receiving a request message from a master device, of a group of one or more devices, on behalf of the group, wherein: the request message contains a group identification (ID) of the group; and the request message is for a positioning reference signal (PRS); and transmitting a PRS to at least one of the one or more devices in the group in response to the request message.

Clause 24: The method of Clause 23, wherein an ID of each of the one or more devices of the group are pre-stored at the network entity.

Clause 25: The method of any combination of Clauses 23-24, wherein the request message requests transmission of the PRS.

Clause 26: The method of any combination of Clauses 23-25, wherein the request message requests a change or update of a transmission characteristic of the PRS.

Clause 27: The method of any combination of Clauses 23-26, further comprising transmitting a PRS to at least one of the one or more devices of the group in response to the request message.

Clause 28: The method of Clause 27, further comprising receiving one or more PRS measurement reports from the at least one device.

Clause 29: The method of Clause 28, further comprising transmitting assistance data to the at least one device in response to the one or more PRS measurement reports.

Clause 30: The method of any combination of Clauses 23-29, wherein the group of devices share at least one common characteristic, the at least one common characteristic comprising at least one of: a type of the one or more devices, a type of one or more applications associated with the one or more devices, one or more radio frequency characteristics associated with the one or more devices, one or more capabilities of the one or more devices, one or more traffic patterns of the one or more devices, or one or more locations of the one or more devices.

Clause 31: The method of Clause 30, wherein the type of the one or more devices comprises at least one of: wearable devices, industrial sensors, or video surveillance cameras.

Clause 32: The method of any combination of Clauses 30-31, wherein the one or more locations of the one or more devices comprises the one or more locations of the one or more devices being covered by at least one of: one or more base stations, one or more cells, or a pre-defined area.

Clause 33: The method of any combination of Clauses 23-32, wherein the request message is an on-demand mobile-originated location request (MO-LR) message.

Clause 34: The method of Clause 33, wherein the MO-LR message includes a request for a PRS configuration.

Clause 35: The method of Clause 34, wherein the request for the PRS configuration includes at least one of: a PRS configuration ID of a predefined PRS configuration.

Clause 36: The method of Clause 34, wherein the request for the PRS configuration includes one or more explicit requested parameters for the PRS configuration.

Clause 37: The method of any combination of Clauses 23-36, wherein the request message is a location service request message.

Clause 38: The method of any combination of Clauses 23-37, wherein the request message further contains an indication that the request message is from the master of the group on behalf of the group.

Clause 39: The method of any combination of Clauses 23-38, wherein the request message further comprises an ID of each of the one or more devices.

Clause 40: The method of any combination of Clauses 23-39, wherein the request message is an on-demand downlink PRS request (NR-On-Demand-DL-PRS-Request).

Clause 41: The method of any combination of Clauses 23-40, wherein the request message further contains a requested start time and a requested duration of the PRS transmission.

Clause 42: The method of any combination of Clauses 23-41, wherein the master device is assigned by: a fixed assignment, a random selection, a rotating assignment, or a designated device.

Clause 43: The method of any combination of Clauses 23-42, wherein the network entity is a base station.

Clause 44: The method of any combination of Clauses 23-43, wherein the network entity is a location management function (LMF).

Clause 45: The method of any combination of Clauses 23-44, transmitting a PRS configuration request to a base station, the PRS configuration request initiating a PRS configuration exchange procedure, wherein the network entity is a location management function (LMF).

Clause 46: The method of any combination of Clauses 23-44, further comprising receiving the PRS configuration request from the LMF, wherein the network entity is the BS.

Clause 47: An apparatus, comprising: a memory comprising executable instructions; and one or more processors configured to execute the executable instructions and cause the apparatus to perform a method in accordance with any one of Clauses 1-21.

Clause 48: An apparatus, comprising means for performing a method in accordance with any one of Clauses 1-21.

Clause 49: A non-transitory computer-readable medium comprising executable instructions that, when executed by one or more processors of an apparatus, cause the apparatus to perform a method in accordance with any one of Clauses 1-21.

Clause 50: A computer program product embodied on a computer-readable storage medium comprising code for performing a method in accordance with any one of Clauses 1-21.

Clause 51: An apparatus, comprising: a memory comprising executable instructions; and one or more processors configured to execute the executable instructions and cause the apparatus to perform a method in accordance with any one of Clauses 23-46.

Clause 52: An apparatus, comprising means for performing a method in accordance with any one of Clauses 23-46.

Clause 53: A non-transitory computer-readable medium comprising executable instructions that, when executed by one or more processors of an apparatus, cause the apparatus to perform a method in accordance with any one of Clauses 23-46.

Clause 54: A computer program product embodied on a computer-readable storage medium comprising code for performing a method in accordance with any one of Clauses 23-46.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration. Further, a processor may be an application processor, host processor, processing units (such as central processing units (CPUs), graphics processing units (GPUs), neural processing units (NPUs) (also referred to as neural network processors or deep learning processors (DLPs)), data processing units (DPUs), associative processing units (APUs), tensor processing units (TPUs), language processing units (LPU), vision processing units (VPUs), quantum processing units (QPUs), processing blocks, or other discrete gate or transistor logic or circuitry (each of which may be generally referred to herein individually as “a processor” or “processor circuitry).

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. A group of processors collectively configurable or configured to perform a set of operations may include a first processor configurable or configured to perform a first operation of the set and a second processor configurable or configured to perform a second, different operation of the set. In some other examples, each of a group of processors may be configurable or configured to perform a same set of operations. Similarly, “a memory,” “at least one memory” or “one or more memories” generally refers to a single memory configured to store data and/or instructions, multiple memories configured to collectively store data and/or instructions.

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a UE may also (or instead) be performed by a network entity (e.g., a BS or unit of a disaggregated BS). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b. Also, as used herein, the terms “has,” “have,” “having,” “comprise,” “comprising,” “include” and “including,” and derivatives thereof or similar terms are intended to be open-ended terms that do not limit an element that they modify (for example, an element “having” a also may have b).

As used herein, the term “determine” or “determining” encompasses one or more of a variety of actions. For example, “determining” can include one or more of calculating, computing, processing, deriving, detecting, estimating, investigating, looking up, inferring, ascertaining, measuring, resolving, selecting, obtaining, choosing, identifying, interpreting, demodulating, decoding, reading, establishing, forming, or generating, among other examples. In some examples, determining can involve a processing system performing some type of calculating, computing, deriving, estimating, inferring, ascertaining, resolving, predicting, or other processing to obtain one or more numerical values, sets, elements, or other information or results. In some examples, determining can involve a processing system identifying, looking up, investigating, or otherwise obtaining some type of value, set, element, or other information or result from a table, data structure, database, or an implementation of memory, such as from a larger set of values, sets, or elements or other information or results. In some examples, determining can involve a processing system identifying, interpreting, demodulating, decoding, detecting, reading, or otherwise obtaining some type of value, set, element, or other information or result signaled in, for example, a received wireless signal. In some examples, determining can involve a processing system performing a measurement, such as on a received signal.

As used herein, the phrase “based on” is equivalent to “based at least in part on” and indicates a non-limiting relationship between elements “a” and “b.” In some aspects, a′ (which may be a variation or example of a) may be responsive to or in response to b′ (which may be a variation or example of b), such as if condition c is met. In some other aspects, a″ (which may be a variation or example of at least one of a or a′) may be associated with b″ (which may be a variation or example of at least one of b or b′). In some further aspects, a′″ (which may be a variation or example of at least one of a or a′ or a″) may be determined (or any of the other actions encompassed by usage of the word “determining” as described above) in accordance with b″ (which may be a variation or example of at least one of b or b′ or b″). Furthermore, what follows the phrase “in accordance with,” “as a function of,” “in response to,” “responsive to,” or “using” is not necessarily the focal point or primary factor associated with the limitation preceding the phrase. For example, the phrases “in accordance with,” “based on,” “based at least in part on,” “as a function of,” “in response to,” “responsive to,” “associated with,” or “using” are not to be construed as a reference to a closed set of conditions, factors, criteria, elements, components or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for wireless communications, the method comprising:
initiating, by a master device of a group of one or more devices that share at least one common characteristic, a request on behalf of the group, wherein:
initiating the request comprises sending a request message to a network entity for a positioning reference signal (PRS); and
the request message contains a group identification (ID).

2. The method of claim 1, wherein the request message requests transmission of the PRS.

3. The method of claim 1, wherein the request message requests a change or update of a transmission characteristic of the PRS.

4. The method of claim 1, further comprising receiving a PRS from the network entity in response to the request message.

5. The method of claim 4, further comprising:
measuring the PRS; and
sending one or more PRS measurement reports to the network.

6. The method of claim 5, further comprising receiving assistance data from the network entity in response to the one or more PRS measurement reports.

7. The method of claim 1, wherein the at least one common characteristic comprises at least one of: a type of the one or more devices, a type of one or more applications associated with the one or more devices, one or more radio frequency characteristics associated with the one or more devices, one or more capabilities of the one or more devices, one or more traffic patterns of the one or more devices, or one or more locations of the one or more devices.

8. The method of claim 7, wherein the type of the one or more devices comprises at least one of: wearable devices, industrial sensors, or video surveillance cameras.

9. The method of claim 7, wherein the one or more locations of the one or more devices comprises the one or more locations of the one or more devices being covered by at least one of: one or more base stations, one or more cells, or a pre-defined area.

10. The method of claim 1, wherein the request message is an on-demand mobile-originated location request (MO-LR) message.

11. The method of claim 10, wherein the MO-LR message includes a request for a PRS configuration.

12. The method of claim 11, wherein the request for the PRS configuration includes at least one of: a PRS configuration ID of a predefined PRS configuration.

13. The method of claim 11, wherein the request for the PRS configuration includes one or more explicit requested parameters for the PRS configuration.

14. The method of claim 1, wherein the request message is a location service request message.

15. The method of claim 1, wherein the request message further contains an indication that the request message is from the master of the group on behalf of the group.

16. The method of claim 1, wherein the request message further comprises an ID of each of the one or more devices.

17. The method of claim 1, wherein the request message is an on-demand downlink PRS request (NR-On-Demand-DL-PRS-Request).

18. The method of claim 1, wherein the request message further contains a requested start time and a requested duration of the PRS.

19. The method of claim 1, wherein the master device is assigned by: a fixed assignment, a random selection, a rotating assignment, or a designated device.

20. The method of claim 1, wherein the network entity is a base station.

21. The method of claim 1, wherein the network entity is a location management function (LMF).

22. An apparatus for wireless communications, the apparatus comprising:
memory storing computer executable code; and
one or more processors configured to execute the computer executable code to cause the apparatus to:
initiating, by a master device of a group of one or more devices that share at least one common characteristic, a request on behalf of the group, wherein:
initiating the request comprises sending a request message to a network for a positioning reference signal (PRS); and
the request message contains a group identification (group ID).

23. A method for wireless communications by a network entity, the method comprising:
receiving a request message from a master device, of a group of one or more devices, on behalf of the group, wherein:
the request message contains a group identification (ID) of the group; and
the request message is for a positioning reference signal (PRS); and
transmitting a PRS to at least one of the one or more devices in the group in response to the request message.

24. The method of claim 23, wherein an ID of each of the one or more devices of the group are pre-stored at the network entity.

25. The method of claim 23, further comprising:
transmitting a PRS configuration request to a base station (BS), the PRS configuration request initiating a PRS configuration exchange procedure, wherein the network entity is a location management function (LMF); or
receiving the PRS configuration request from the LMF, wherein the network entity is the BS.
